(19) United States
(12) Patent Application Publication
(10) Pub. No.: US 2020/0110384 A1
(43) Pub. Date: Apr. 9, 2020

(54) PROCESSING DATA CREATION METHOD, LASER PROCESSING METHOD, PROCESSING DATA CREATION SYSTEM, PROCESSING SYSTEM, PROCESSING DATA CREATION PROGRAM, AND PROCESSING PROGRAM

(71) Applicant: ROLAND DG CORPORATION, Hamamatsu-shi, Shizuoka (JP)

(72) Inventors: Makoto YOSHIDA, Hamamatsu-shi (JP); Toshio MAEDA, Hamamatsu-shi (JP); Jun UEDA, Hamamatsu-shi (JP)

(21) Appl. No.: 16/611,504

(22) PCT Filed: May 16, 2018
(86) PCT No.: PCT/JP2018/018876

§ 371 Date: Nov. 7, 2019

(30) Foreign Application Priority Data
May 22, 2017 (JP) 2017-100571

(51) Int. Cl. G05B 19/4093; B23K 26/55; G05B 19/23

(52) U.S. Cl. CPC G05B 19/40938; G05B 19/40932; G05B 19/23; B23K 26/55

(57) ABSTRACT

A processing data creation method of creating processing data to be used when a target object is formed inside a material by laser processing includes setting an impingement path for a laser beam inside the material in accordance with shape data indicating a shape of the target object, and creating the processing data by adjusting a location of the impingement path in an impingement direction of the laser beam in accordance with a refractive index of the material.

### BACKGROUND OF THE INVENTION

### 1. Field of the Invention

The present invention relates to a processing data creation method, a laser processing method, a processing data creation system, a processing system, a processing data creation program, and a processing program.

### 2. Description of the Related Art

Laser processing apparatuses are known to process a material using a laser to create a target object. Material may be processed, for example, in accordance with processing data created in advance with a computer-aided design/computer-aided manufacturing (CAD/CAM) system.

With such laser processing apparatuses, work to adjust a focal point of a laser beam so as to match a predetermined height of a material surface or a predetermined height inside the material (focal point adjustment) needs to be performed prior to carrying out actual laser processing.

With regard to such adjustment, since the optical path length of a laser beam is longer inside a transparent material than in air due to the influence of the refractive index of the material, studies have been conducted on a method in which the refractive index of a material is taken into consideration when performing focal point adjustment (see “Femtosecond Laser Micro-nanomachining system”, [online], Tokyo Instruments, Inc., Internet <URL: http://www.tokyoinst.co.jp/product#file/file/TI01#tec01#ja.pdf> [retrieved on May 8, 2017]).

In actual laser processing, when processing the inside of a material, a laser beam impingement location varies according to the target object surface profile.

Variations in the laser beam impingement location are accompanied by variations in the optical path length of the laser beam inside the transparent material. That is to say, even if focal point adjustment is performed using a method such as that disclosed in “Femtosecond Laser Micro-nanomachining system”, [online], Tokyo Instruments, Inc., Internet <URL: http://www.tokyoinst.co.jp/product#file/file/TI01#tec01#ja.pdf> [retrieved on May 8, 2017], the adjustment is affected by the refractive index of the material in the actual laser processing. Accordingly, even if the processing is performed in accordance with the processing data having been created in advance, it is difficult to create an accurate target object.

### SUMMARY OF THE INVENTION

Preferred embodiments of the present invention provide techniques for creating processing data for accurately processing a target object, as well as techniques for accurately processing a target object using the created processing data.

According to a preferred embodiment of the present invention, a processing data creation method of creating processing data to be used when a target object is formed inside a material by laser processing includes setting an impingement path for a laser beam inside the material in accordance with shape data indicating a shape of the target object, and creating the processing data by adjusting a location of the impingement path in an impingement direction of the laser beam in accordance with a refractive index of the material.

According to another preferred embodiment of the present invention, a laser processing method includes impinging the laser beam in accordance with the processing data created through the aforementioned processing data creation method to form the target object inside the material.

Other features of preferred embodiments of the present invention will be revealed in the present disclosure.

According to preferred embodiments of the present invention, it is possible to create processing data usable to accurately process a target object. Moreover, according to preferred embodiments of the present invention, a target object is accurately processed using the processing data.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic diagram illustrating a configuration of a processing system, a CAM system, and a CAD system according to a preferred embodiment of the present invention.

FIG. 2 is a diagram illustrating a hardware configuration of a CAM system according to a preferred embodiment of the present invention.

FIG. 3 is a diagram illustrating a software configuration of a CAM system according to a preferred embodiment of the present invention.

FIG. 4 is a diagram schematically illustrating a portion of a material according to a preferred embodiment of the present invention.

FIG. 5 is a diagram schematically illustrating a portion of a material according to a preferred embodiment of the present invention.

FIG. 6 is a diagram schematically illustrating a portion of a material according to a preferred embodiment of the present invention.

FIG. 7 is a flowchart illustrating operations of a CAM system and a processing system according to a preferred embodiment of the present invention.

### DETAILED DESCRIPTION OF THE PREFERRED EMBODIMENTS

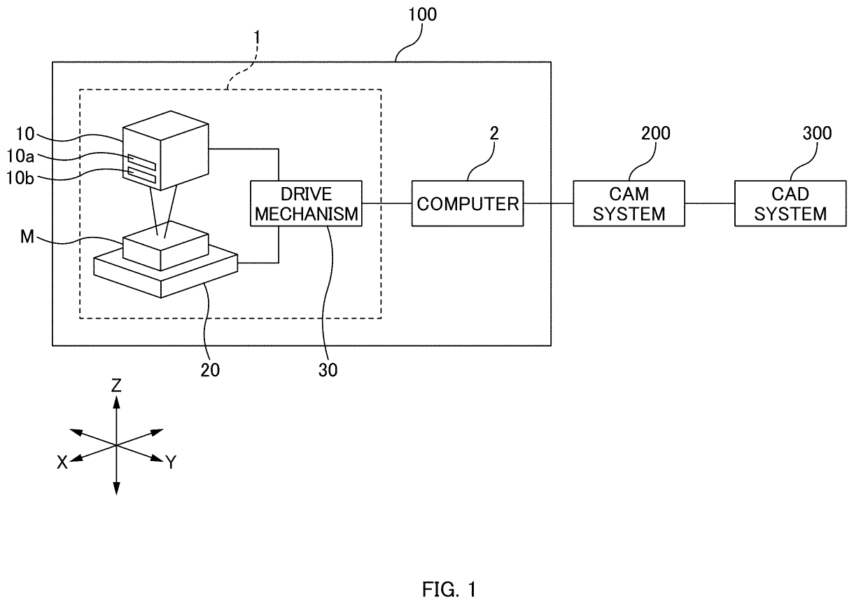

FIG. 1 is a diagram schematically illustrating a processing system 100, a computer-aided manufacturing (CAM) system 200, and a computer-aided design (CAD) system 300 according to a preferred embodiment of the present invention.

The processing system 100 processes a material in a contactless manner using a laser beam to create a desired target object. The CAM system 200 creates processing data which is used in the processing system 100. The CAD system 300 creates shape data which indicates the shape of the target object. The shape data may be, for example, three-dimensional data pertaining to the target object, and specifically, may be standard triangulated language (STL) data, solid data used in three-dimensional CAD, data for 3D manufacturing format (3MF) or additive manufacturing format (AMF) used in a 3D printer, or the like. Note that the CAM system 200 and the CAD system 300 may be configured as one unified system.

The processing system 100 includes a laser processing apparatus 1 and a computer 2. Note that the processing system 100 may include the laser processing apparatus 1 alone given that functions of the computer 2 are implemented by the laser processing apparatus 1.

The laser processing apparatus 1 impinges a laser beam onto a material M in accordance with processing data created in advance, so as to process a surface or the inside of the material M.

The laser processing apparatus 1 includes an emission unit 10, a retaining unit 20, and a drive mechanism 30.

The emission unit 10 emits a laser beam onto the material M. The emission unit 10 includes, for example, a laser beam oscillator 10a and a lens group 10b to allow a laser beam from the oscillator 10a to converge to a predetermined location. The location to which the laser beam converges coincides with an “impingement location”. Note that the laser beam oscillator 10a may be provided on the outside of the laser processing apparatus 1, and the emission unit 10 may be provided with an adjustment mechanism (not illustrated in the drawings) that varies the impingement location by adjusting the focal point distance of the lens group 10b.

The material M according to this preferred embodiment is a material that transmits a laser beam (transparent material). Examples of the transparent material include glass material, highly light-transmissive resin material (e.g. acrylic resin), zirconia-based light-transmissive material (composite material such as glass-ceramics containing zirconia or a zirconia simple substance having a certain degree of transmittance), etc. It is not required that the transmittance of the transparent material be 100%, and it is sufficient if the transmittance is a value such that a laser beam can reach a predetermined location within the material (a location at which to form the target object).

An ultrashort-pulsed laser beam preferably is used for the laser beam. An ultrashort-pulsed laser beam is a laser beam, the width of a single pulse of which is several picoseconds to several femtoseconds. Short impingement of an ultrashort-pulsed laser beam onto an area subject to processing in a material makes it possible to carry out abrasion processing (non-thermal processing). Abrasion processing is a method for melting or gasifying a material by laser beam impingement. A material that has been melted or gasified (turned into plasma) momentarily evaporates, scatters, and is removed, so a cavity forms at the location onto which the laser beam has impinged. Compared to typical heat processing, abrasion processing causes less heat-related damage to the portion being processed.

The retaining unit 20 retains the material M. A method for retaining the material M is not particularly limited as long as the material M being retained can be moved along a drive axis of the laser processing apparatus 1. The retaining unit 20 illustrated in FIG. 1 is configured in the form of a table on which the material M is placed, but the retaining unit 20 may instead be configured to retain the material M by, for example, sandwiching the same.

The drive mechanism 30 moves the emission unit 10 and the retaining unit 20 relative to each other. The drive mechanism includes, for example, a servomotor. In this preferred embodiment, the drive mechanism 30 can adjust the positional relationship between the emission unit 10 and the retaining unit (the material M retained by the retaining unit 20) by moving the emission unit 10 and the retaining unit 20 relative to each other along drive axes including three axes (X, Y, Z axes).

In this preferred embodiment, the X-axis direction corresponds to the material M longitudinal direction, the Y-axis direction corresponds to the material M lateral direction, and the Z-axis direction corresponds to the material M height direction. The material M height direction is a direction perpendicular to the material M width direction (the X-axis direction or the Y-axis direction).

It is sufficient if the emission unit 10 and the retaining unit 20 are movable in the X-, Y-, Z-axis directions relative to each other. For example, a configuration may be adopted in which the emission unit 10 is movable only in the Z-axis direction while the retaining unit 20 is movable in the X-axis direction and the Y-axis direction; or a configuration may be adopted in which the retaining unit 20 is immovable and the emission unit 10 is movable in the X-, Y-, Z-axis directions. The number of drive axes of the laser processing apparatus 1 is not limited to three. For example, a configuration may be adopted in which the drive axes include five axes (X-axis, Y-axis, Z-axis, A rotation axis (rotation axis about X-axis), and B rotation axis (rotation axis about Y-axis)).

The computer 2 is configured or programmed to control operations of various configurations included in the laser processing apparatus 1. For example, the computer 2 may control the drive mechanism 30 so as to adjust the relative positional relationship between the emission unit 10 and the material M retained by the retaining unit 20. Alternatively, the computer 2 may use the processing data (to be described later) to control the emission unit 10 and the drive mechanism 30 such that a laser beam is impinged to the inside of the material M. The computer 2 is an example of a “controller” and/or “processor” or “processors” included in the processing system 100.

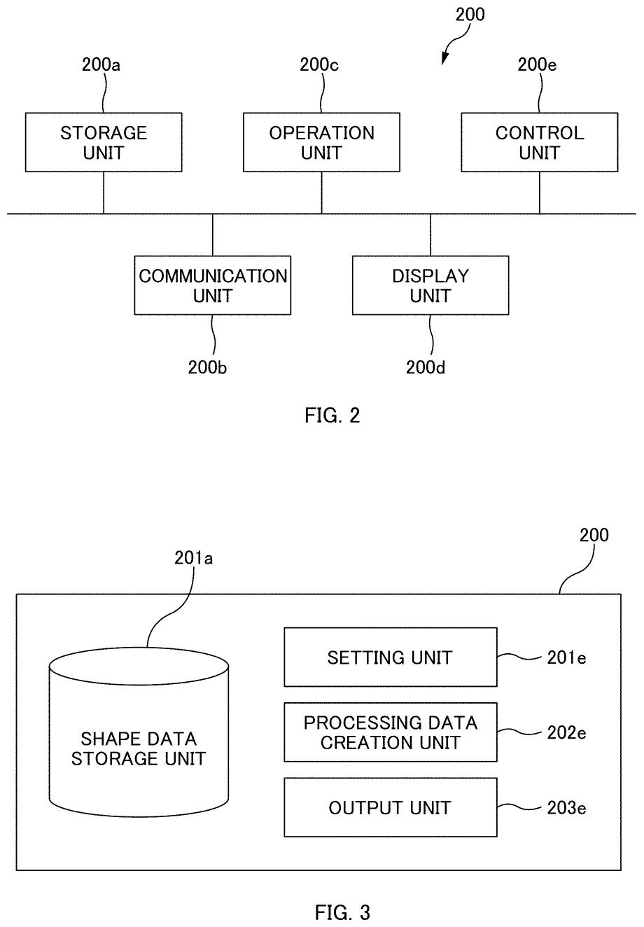

FIG. 2 is a diagram illustrating an example of a hardware configuration of the CAM system 200. The CAM system 200 includes a storage unit 200a, a communication unit 200b, an operation unit 200c, a display unit 200d, and a control unit 200e.

The storage unit 200a stores various information relating to the CAM system 200 and data used in the CAM system 200. The communication unit 200b provides an interface to connect the CAM system 200 with the processing system 100 and the CAD system 300 (see FIG. 1). The operation unit 200c is a configuration used by an operator to perform various operation inputs to the CAM system 200. The operation unit 200c may include, for example, a mouse, a keyboard, or a graphical user interface (GUI) displayed on the display unit 200d. The display unit 200d provides a display screen for, for example, displaying various information and creating processing data.

The control unit 200e is a controller that is configured or programmed to control various processing in the CAM system 200. The control unit 200e includes a Central Processing Unit (CPU) and a memory (neither of these are illustrated in the drawings). The CPU or processor(s) is configured or programmed to implement various functions by executing an operation program or programs stored in the memory. The operation program may be executed by, for example, starting up pre-installed processing data creation software.

FIG. 3 is a diagram illustrating an example of a software configuration of the CAM system 200. The CAM system 200 includes a shape data storage unit 201a, a setting unit 201e, a processing data creation unit 202e, and an output unit 203e. The shape data storage unit 201a is provided as a portion of a storage area of the storage unit 200a. The setting unit 201e, the processing data creation unit 202e, and the output unit 203e are implemented as a result of the CPU of the control unit 200e executing the operation program stored in the memory.

The shape data storage unit 201a stores the shape data indicating the shape of the target object. The shape data may be created in the CAD system 300, for example.

The setting unit 201e sets an impingement path for a laser beam inside the material in accordance with the shape data indicating the shape of the target object.

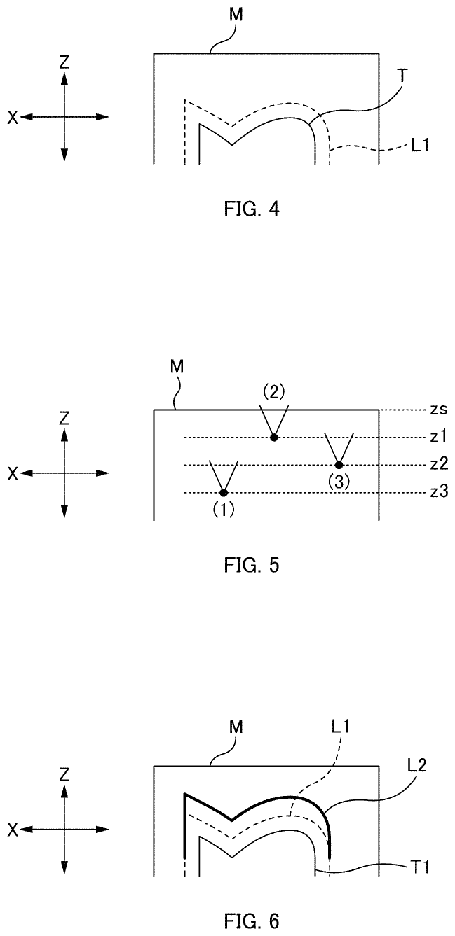

FIG. 4 is a diagram schematically illustrating a relationship between the surface profile of the target object T to be formed inside the material M and a corresponding laser beam impingement path.

When impinging a laser beam onto a material, the spot diameter of the laser beam needs to be taken into consideration. When the target object T has a surface profile such as that illustrated in FIG. 4 and a laser beam is impinged onto this surface, then the target object T is processed further to an inner side than the surface by an amount equivalent to the spot diameter of the laser beam. Thus, an accurate shape of the target object T cannot be obtained. In view of this, the laser beam needs to be impinged further to an outer side than the surface of the target object T by an amount equivalent to the spot diameter. Alternatively, it is also conceivable to perform finishing processing, such as grinding, after performing laser processing; in this case too, the laser beam needs to be impinged further to an outer side than the surface of the target object T.

Specifically, the setting unit 201e sets the impingement path L1 of the laser beam at a location that is further to an outer side than the surface of the target object T by a predetermined amount. The predetermined amount may be set in accordance with, for example, the spot diameter of the laser beam to be used or the amount of grinding (thickness to be ground) in the finishing step. The location of the surface of the target object T may be determined using coordinate values (e.g. three-dimensional (X, Y, Z) coordinate values) included in the shape data.

The impingement path L1 may be formed using, for example, point group data indicating a point group including a plurality of points. The plurality of point data items included in the point group data items each include three-dimensional (XYZ) coordinate values.

The processing data creation unit 202e creates the processing data by adjusting a location of the impingement path in the impingement direction of the laser beam in accordance with the refractive index of the material.

The “impingement direction of the laser beam” indicates a direction in which the laser beam is impinged onto a given surface of a material. In this preferred embodiment, it is assumed that the impingement direction of the laser beam corresponds to the material height direction (Z-axis direction). In this case, the “location of the impingement path in the impingement direction of the laser beam” corresponds to a location of the impingement path in the Z-axis direction (Z-axis coordinate value).

Now, an outline of a refractive index-based adjustment according to this preferred embodiment will be described with reference to FIG. 5. FIG. 5 is a diagram schematically illustrating changes in the laser beam impingement location in the material M height direction. In FIG. 5, “zs” indicates the material M surface height and “z1” through “z3” indicate heights of laser beam impingement locations inside the material M. The refractive index of the material M is indicated by “N”. The material M surface height zs and the refractive index N are input in advance by the operator through the operation unit 200c.

When a laser beam is impinged on the inside of the material M, the optical path length of the laser beam is affected by the refractive index. For example, a case is assumed where it is intended to impinge a laser beam onto a given height z2 inside the material and the laser beam impingement location is set to the height z2. In this case, the optical path length of the laser beam emitted will be lengthened by an amount equivalent to the refractive index N. Thus, in actuality, the laser beam will impinge onto the location of the height z3 (see (1) in FIG. 5). In other words, even if an impingement path that conforms to the surface profile of the target object is set while taking a spot diameter, or the like, into consideration, the actual laser beam cannot be impinged along the impingement path having been set, because of the influence of the refractive index N.

Thus, when it is intended to impinge the laser beam onto the location of the height z2, the laser beam impingement location needs to be adjusted in accordance with the refractive index N. Specifically, an adjustment is carried out such that the optical path length from the material M surface height zs to the height z2 is 1/N and the laser beam is impinged onto the location of the height z1 (see (2) in FIG. 5). In this case, the actual location onto which the laser beam impinges is the location of the height z2 (see (3) in FIG. 5).

This height z1 is calculated by formula (1) below. Expression 1

z1=zs−(zs−z2)/N (1)

An impingement path L2 created by carrying out the aforementioned adjustment is illustrated in FIG. 6. The location of the impingement path L2 in the material M height direction is shifted overall further to an upper side (the material M surface side) than the impingement path L1. Data indicating such an impingement path L2 is an example of the “processing data”.

In a case where the impingement path L1 is formed using point group data, the processing data creation unit 202e carries out the aforementioned adjustment for each point included in the point group data to create an impingement path L2 which is formed using the point group data having undergone the adjustment.

The output unit 203e outputs the created processing data to the processing system 100. In the example above, the output unit 203e outputs data for the created impingement path L2 to the processing system 100.

In this way, the CAM system 200 according to this preferred embodiment can create processing data to be used when a target object is formed inside a material by laser processing. That is to say, the CAM system 200 corresponds to the “processing data creation system”.

The processing system 100 carries out laser beam impingement in accordance with the processing data for the impingement path L2 (i.e., along the impingement path L2). Here, in actuality, the laser beam will impinge onto the processing path L1, so the processing that was originally intended can be carried out.

If the impingement path L2 is formed using point group data, laser beam impingement is carried out for each point.

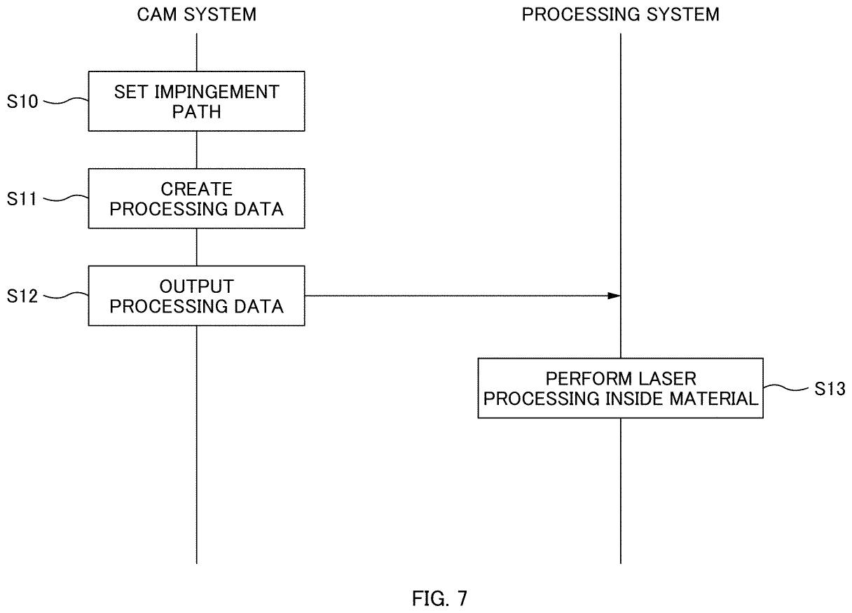

Processing relating to processing data creation and laser processing according to this preferred embodiment will be described with reference to FIG. 7. FIG. 7 is a flowchart illustrating the processing system 100 and the CAM system 200.

The setting unit 201e sets an impingement path for the laser beam inside the material in accordance with the shape data created by the CAD system 300 (step 10: set impingement path).

The processing data creation unit 202e creates the processing data by adjusting the location of the impingement path having been set in step 10 in the impingement direction of the laser beam in accordance with the refractive index (step 11: create processing data).

The output unit 203e outputs the processing data having been created in step 11 to the processing system 100 (step 12: output processing data).

The processing system 100 processes the inside of the material by impinging a laser beam thereon in accordance with the processing data having been output in step 12 (step 13: perform laser processing inside material). The processing in step 13 may be executed by, for example, the computer 2: controlling the drive mechanism 30 so as to move the emission unit 10 and the retaining unit 20 relative to each other along the impingement path indicated by the processing data; and concurrently controlling the emission unit 10 so as to perform laser beam impingement.

As described above, in this preferred embodiment, the following method can be carried out in the CAM system 200, namely a method including: setting an impingement path for a laser beam inside the material M in accordance with shape data indicating the shape of the target object; and creating the processing data by adjusting a location of the impingement path in an impingement direction of the laser beam in accordance with a refractive index of the material M. Setting of the impingement path is carried out by the setting unit 201e and creation of the processing data is carried out by the processing data creation unit 202e. Within the impingement path of the laser beam, the location of the path in the impingement direction of the laser beam is adjusted in accordance with the refractive index of the material, so it is possible to create processing data for which variations in optical path length due to the influence of the refractive index are taken into consideration. Such processing data enables accurate processing of a target object.

Moreover, in the CAM system 200 in this preferred embodiment, if the laser impingement path having been set is formed using point group data, it is possible to carry out adjustment for each point included in the point group data using the refractive index. By carrying out such adjustment for each point using the refractive index, it is possible to create more accurate processing data.

Further, the processing system 100 according to this preferred embodiment can carry out a method including impinging the laser beam in accordance with the processing data having been created by the CAM system 200 to form the target object inside the material M. Laser beam impingement is carried out as a result of the controller 2 controlling the emission unit 10 and the drive mechanism 30. By carrying out the processing using the aforementioned processing data, it is possible to accurately process the target object.

In a preferred embodiment of the present invention described above, an example was described in which processing data created by the CAM system 200 is used in the processing system 100. Meanwhile, it is also possible to have the processing system 100 carry out similar processing to the processing at the CAM system 200.

For example, the CAM system 200 outputs shape data created by the CAD system 300 and information pertaining to the refractive index of the material M selected by the operator to the processing system 100.

The controller 2 sets an impingement path for the laser beam inside the material in accordance with the shape data indicating the shape of the target object. The controller 2 creates the processing data by adjusting the location of the impingement path in the impingement direction of the laser beam in accordance with the refractive index of the material. Then, in accordance with the processing data created by the controller 2 itself, the controller 2 controls the emission unit 10 and the drive mechanism 30 so as to impinge the laser beam on the inside of the material.

Even when the processing data is created at the processing system 100 as described above, the influence of the refractive index is taken into consideration for the processing data. Accordingly, by carrying out the processing using this processing data, it is possible to accurately process the target object. Note that a configuration may be adopted in which the processing up to setting of the impingement path is carried out at the CAM system 200 whereas the controller 2 carries out processing to create the processing data in accordance with the impingement path having been set.

The processing data creation method and the laser processing method according to preferred embodiments described above can be configured as a program.

For example, it is possible to configure a processing data creation program which causes a computer to set an impingement path for a laser beam inside the material in accordance with shape data indicating the shape of the target object, and create the processing data by adjusting a location of the impingement path in an impingement direction of the laser beam in accordance with a refractive index of the material.

In addition, it is possible to configure a processing program causing a computer to set an impingement path for a laser beam inside the material in accordance with shape data indicating the shape of the target object, create the processing data by adjusting a location of the impingement path in an impingement direction of the laser beam in accordance with a refractive index of the material, and impinge the laser beam on the inside of the material in accordance with the processing data.

The “computer” that executes these programs may be, for example, the CAM system 200 or the computer 2.

By executing the aforementioned processing data creation program, it is possible to create processing data usable to accurately process a target object. Moreover, by executing the aforementioned processing program, it is possible to accurately process a target object using the created processing data.

It is also possible to use a non-transitory computer readable medium with such an executable program thereon to supply the program to a computer. Examples of such a non-transitory computer readable medium include magnetic recording media (flexible disc, magnetic tape, hard disk drive, etc.), compact disk-read only memory (CD-ROM), and the like.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-7. (canceled)

8: A processing data creation method of creating processing data to be used when a target object is formed inside a material by laser processing, the method comprising:
setting an impingement path for a laser beam inside the material in accordance with shape data indicating a shape of the target object; and
creating the processing data by adjusting a location of the impingement path in an impingement direction of the laser beam in accordance with a refractive index of the material.

9: The processing data creation method according to claim 8, wherein
the impingement path is formed using point group data; and
the creating step includes using the refractive index to carry out adjustment for each point included in the point group data.

10: A laser processing method comprising impinging the laser beam in accordance with the processing data created through the creation method set forth in claim 8 to form the target object inside the material.

11: A processing data creation system to create processing data to be used when a target object is formed inside a material by laser processing, the system comprising:
a setting processor configured or programmed to set an impingement path for a laser beam inside the material in accordance with shape data indicating a shape of the target object; and
a processing data creation processor configured or programmed to create the processing data by adjusting a location of the impingement path in an impingement direction of the laser beam in accordance with a refractive index of the material.

12: A processing system to form a target object inside a material by laser processing, the system comprising:
an emitter to emit a laser beam;
a retainer to retain the material;
a driver to move the emitter and the retainer relative to each other; and
a controller configured or programmed to control the emitter and the driver to impinge a laser beam on the inside of the material in accordance with processing data created by adjusting, in accordance with a refractive index of the material, a location of an impingement path of the laser beam in an impingement direction of the laser beam, the impingement path being located inside the material and set in accordance with shape data indicating a shape of the target object.
